(19) United States
(12) Patent Application Publication
(10) Pub. No.: US 2026/0287359 A1
(43) Pub. Date: Sep. 24, 2026

(54) SYSTEMS AND METHODS FOR MEASURING ROTATION AND VELOCITY

(71) Applicant: SEZANNE MARINE LIMITED, Argyll (GB)

(72) Inventor: Ceri Reid, Central Scotland (GB)

(21) Appl. No.: 19/473,964

(22) PCT Filed: Apr. 15, 2024
(86) PCT No.: PCT/GB2024/050980

§ 371 Date: Oct. 9, 2025

(30) Foreign Application Priority Data
Apr. 13, 2023 (GB) 2305465.3

(51) Int. Cl. G01C 19/72

(52) U.S. Cl. CPC G01C 19/721

(57) ABSTRACT

The disclosed technology includes a gyroscope comprising: a transmitter configured to transmit a signal, the time of the first signal transmission defining the start of a sample period; a receiver 5 configured to receive the signal; a path connecting the transmitter and receiver, along which the signal travels; and a processor, wherein: the transmitter is configured to retransmit the signal in response to the signal being received at the receiver throughout the sample period; the processor is configured to determine the time between the first signal transmission and the reception of the final retransmitted signal when the sample period has ended; and the processor is further 10 configured to use the time between the first signal transmission and the reception of the final retransmitted signal to determine a corresponding rotation of the gyroscope over the sample period.

### FIELD

The present technology relates to systems and methods for measuring rotation and velocity, including fibre optic gyroscopes, and to the use of such gyroscopes in gyrocompasses.

### BACKGROUND

Magnetic compasses are commonly used for navigation, and point towards magnetic north. However, magnetic compasses suffer from magnetic deviation caused by local magnetic fields.

Furthermore, the position of magnetic north changes over time, meaning accurate navigation is difficult to achieve.

Gyrocompasses are non-magnetic compasses that can be used in an inertial navigation system, to determine the direction of true or geographic north. Gyrocompasses are unaffected by local magnetic fields, and are therefore more suited for use in ships, for example, where the ship's hull can interfere with magnetic compasses.

It is known to use optical gyroscopes, such as ring laser gyroscopes or fibre optic gyroscopes, in gyrocompasses. However, such optical gyroscopes require complex, highly sophisticated, expensive equipment to obtain accurate measurements.

Improved systems and methods for measuring rotation and velocity are desired.

### BRIEF DESCRIPTION OF THE INVENTION

The disclosed technology includes a gyroscope comprising: a transmitter configured to transmit a signal, the time of the first signal transmission defining the start of a sample period; a receiver configured to receive the signal; a path connecting the transmitter and receiver, along which the signal travels; and a processor, wherein: the transmitter is configured to retransmit the signal in response to the signal being received at the receiver throughout the sample period; the processor is configured to determine the time between the first signal transmission and the reception of the final retransmitted signal when the sample period has ended; and the processor is further configured to use the time between the first signal transmission and the reception of the final retransmitted signal to determine a corresponding rotation of the gyroscope over the sample period.

The gyroscope may further include a clock, and the processor may be configured to use the clock to determine the time between the first signal transmission and the reception of the final retransmitted signal when the sample period has ended.

The clock may include an electronic oscillator.

The gyroscope may further include a vernier delay line time-to-digital converter, and the processor may be configured to use the vernier delay line time-to-digital converter to determine the time between the first signal transmission and the reception of the final retransmitted signal when the sample period has ended.

The processor may be configured to determine the rotation of the gyroscope by comparing the time between the first signal transmission and the reception of the final retransmitted signal to an expected time based on the sample period.

The path may include a coiled portion.

The path may include a first coiled portion defining a first plane and a second coiled portion defining a second plane, wherein the first and second planes are rotationally offset with respect to each other.

The first and second planes may be substantially orthogonal to each other.

In use, the first plane may be substantially horizontal and the second plane may be substantially vertical.

The sample period may be at least 25 μs.

The length of the path connecting the transmitter and receiver may be between 50 m and 25 km.

The path may include a primary route and an alternative route, and the gyroscope may further include: a splitter configured to direct part of the signal along the primary route and part of the signal along the alternative route; and a combiner configured to direct signals from the primary and alternative routes to the receiver.

The primary route and alternative routes may be of different lengths.

The gyroscope may further include a multiplexer configured to pass only one of the received signals from the primary and alternative paths to the transmitter for retransmission.

The signal may include an optical signal.

The gyroscope may be a fibre optic gyroscope and the path may include a fibre optic cable.

The transmitter and receiver may be provided as a transceiver.

The transceiver may be an optical transceiver.

Also disclosed is a gyrocompass including a gyroscope as above.

Also disclosed is a method for measuring rotation of a system, the method comprising: transmitting a signal along a path, the time of the first signal transmission defining the start of a sample period;

receiving the signal at a receiver; throughout the sample period, in response to receiving the signal at the receiver, retransmitting the signal from the transmitter; determining the time between the first signal transmission and the reception of the final retransmitted signal when the sample period has ended; and using the time between the first signal transmission and the reception of the final retransmitted signal to determine a corresponding rotation of the system over the sample period.

The time between the first signal transmission and the reception of the final retransmitted signal when the sample period has ended may be determined using a clock.

The clock may include an electronic oscillator.

The time between the first signal transmission and the reception of the final retransmitted signal when the sample period has ended may be determined using a vernier delay line time-to-digital converter.

The rotation of the system may be determined by comparing the time between the first signal transmission and the reception of the final retransmitted signal to an expected time based on the sample period.

The path may include a coiled portion.

The path may include a first coiled portion defining a first plane and a second coiled portion defining a second plane, wherein the first and second planes are rotationally offset with respect to each other.

The first and second planes may be substantially orthogonal to each other.

The first plane may be substantially horizontal and the second plane may be substantially vertical.

The sample period may be at least 25 μs.

The length of the path connecting the transmitter and receiver may be between 50 m and 25 km.

The path may include a primary route and an alternative route, and the method may further include: splitting the signal to direct part of the signal along the primary route and part of the signal along the alternative route; and directing signals from the primary and alternative routes to the receiver.

The primary route and alternative routes may be of different lengths.

The method may further include using a multiplexer to pass only one of the received signals from the primary and alternative paths to the transmitter for retransmission.

The signal may include an optical signal.

The path may include a fibre optic cable.

The transmitter and receiver may be provided as a transceiver.

The transceiver may be an optical transceiver.

Also disclosed is a system for determining linear velocity, comprising: a first transmitter and a first receiver; a second transmitter and a second receiver; a first path connecting the first transmitter to the first receiver; a second path connecting the second transmitter to the second receiver; and a processor, wherein: the first transmitter is configured to transmit a signal to the first receiver, the time of the first signal transmission defining the start of a sample period; the second transmitter is configured to retransmit the signal to the second receiver in response to the signal being received at the first receiver throughout the sample period; the first transmitter is further configured to retransmit the signal to the first receiver in response to the retransmitted signal being received at the second receiver throughout the sample period; the first and second paths have different baseline signal travel times; the processor is configured to determine the time between the first signal transmission and the reception of the final retransmitted signal at the first or second receiver when the sample period has ended; and the processor is further configured to use the time between the first signal transmission and the reception of the final retransmitted signal at the first or second receiver to determine a corresponding linear velocity over the sample period.

The first transmitter and second receiver may be provided as a first transceiver, and the second transmitter and first receiver may be provided as a second transceiver.

The first and second paths may have different signal propagation speeds and/or different lengths, resulting in the different baseline signal travel times.

The first and second paths may be of different lengths, and at least one of the paths may include an extension section, the extension section including a helical or spiral portion.

Also disclosed is a method for determining linear velocity of a system, comprising: transmitting a signal from a first transmitter to a first receiver along a first path having a first baseline signal travel time, the time of the first signal transmission defining the start of a sample period; retransmitting the signal from a second transmitter to a second receiver along a second path having a second baseline signal travel time different to the first baseline signal travel time in response to the signal being received at the first receiver throughout the sample period; retransmitting the signal from the first transmitter to the first receiver in response to the retransmitted signal being received at the second receiver throughout the sample period; determining the time between the first signal transmission and the reception of the final retransmitted signal at the first or second receiver when the sample period has ended; and using the time between the first signal transmission and the reception of the final retransmitted signal at the first or second receiver to determine a corresponding linear velocity of the system over the sample period.

Also disclosed is a gyroscope comprising: a transmitter configured to transmit a signal; a receiver configured to receive the signal; a path connecting the transmitter and receiver, along which the signal travels; and a processor configured to use a property of the received signal to determine a rotation of the gyroscope, wherein the path includes a first coiled portion defining a first plane and a second coiled portion defining a second plane, wherein the first and second planes are rotationally offset with respect to each other.

The first and second planes may be substantially orthogonal to each other.

Also disclosed is a method for measuring rotation of a system, the method comprising: transmitting a signal along a path including a first coiled portion defining a first plane and a second coiled portion defining a second plane, wherein the first and second planes are rotationally offset with respect to each other; receiving the signal at a receiver; and using a property of the received signal to determine, using a processor, a rotation of the system.

Also disclosed is a gyroscope comprising: a transmitter configured to transmit a signal, the time of the first signal transmission defining the start of a sample period; a receiver configured to receive the signal; a path connecting the transmitter and receiver, along which the signal travels; and a processor, wherein: the transmitter is configured to retransmit the signal in response to the signal being received at the receiver throughout the sample period; the processor is configured to determine the time between the first signal transmission and the reception of the final retransmitted signal when the sample period has ended; and the processor is further configured to use the time between the first signal transmission and the reception of the final retransmitted signal to determine a corresponding rotation of the gyroscope over the sample period, wherein the processor is configured to determine the rotation of the gyroscope by comparing the time between the first signal transmission and the reception of the final retransmitted signal to an expected time based on the sample period, wherein the expected time is a predetermined time that would be taken if the gyroscope were rotating at a predetermined rate.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a schematic view of a gyroscope according to the present disclosure;

FIG. 2 is a schematic view of a gyroscope according to the present disclosure;

FIGS. 3a and 3b are schematic views of a system for measuring linear velocity according to the present disclosure; and

FIG. 4 is a schematic view of an optoelectronic unit according to the present disclosure.

### DETAILED DESCRIPTION OF THE DISCLOSURE

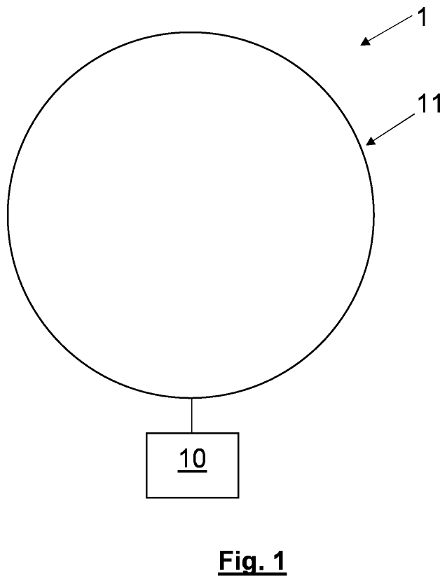

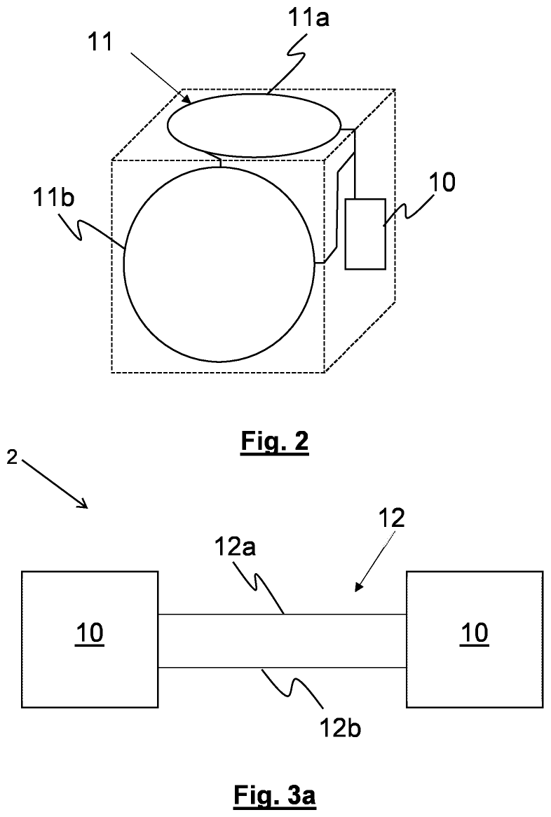

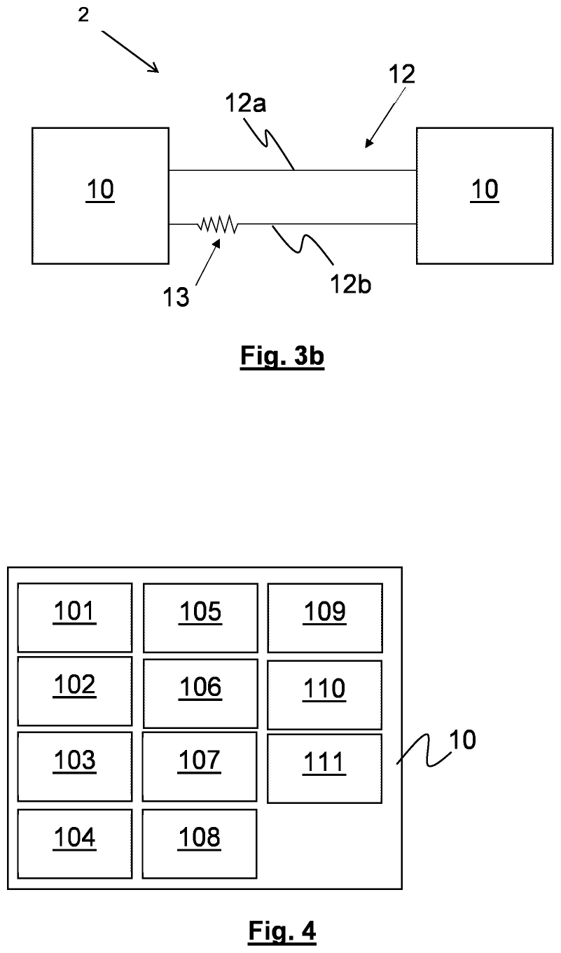

The disclosed technology includes a gyroscope 1 (see e.g. FIGS. 1-2) and a system 2 for determining linear velocity (see e.g. FIGS. 3a and 3b), with associated methods. Any method steps described herein may be stored as instructions on a non-transitory computer-readable medium which, when executed by a processor, cause the performance of the described method.

The gyroscope 1 and/or system 2 may include an optoelectronic unit 10 (see e.g. FIGS. 1-4). The optoelectronic unit 10 may include one or more optical and/or electronic components. The optoelectronic unit 10 may include a housing to house the one or more components. In some versions, the optoelectronic unit 10 may be a distributed optoelectronic unit 10. In other words, one or more of the components of the optoelectronic unit 10 may be provided at a location that is remote from one or more other components of the optoelectronic unit 10. For example, the optoelectronic unit 10 may include one or more cloud-based components. In other versions, all of the components of the optoelectronic unit 10 may be housed together.

It is convenient to illustrate the described technology with reference to the optoelectronic unit 10 (see e.g. FIGS. 1-4). However, it should be appreciated that any component of the optoelectronic unit 10 can be provided separately (i.e. independently).

The gyroscope 1 and/or system 2, optionally the optoelectronic unit 10 (see e.g. FIG. 4), may include a transmitter 101. The transmitter 101 may be configured to transmit a signal. The transmitter 101 may be an optical and/or electronic transmitter 101. The transmitter 101 may, therefore, be configured to transmit an optical signal. The signal may, therefore, comprise a light pulse. The transmitter 101 may be configured to transmit an electrical signal. The transmitter 101 may, for example, be configured to transmit an optical signal through a fibre optic cable.

The gyroscope 1 and/or system 2, optionally the optoelectronic unit 10, may include a receiver 102. The receiver 102 may be configured to receive a signal, which may be the signal transmitted by the transmitter 101. The receiver 102 may be an optical and/or electronic receiver 102. The receiver 102 may, therefore, be configured to receive an optical signal. The receiver 102 may be configured to receive an electrical signal. The receiver 102 may, for example, be configured to receive optical signals through a fibre optic cable.

The transmitter 101 and receiver 102 may be operably coupled. In other words, the transmitter 101 and receiver 102 may be coupled such that an event occurring at either of the transmitter 101 or receiver 102 causes a response at the other of the transmitter 101 or receiver 102.

The transmitter 101 and receiver 102 may be provided as a transceiver 101, 102.

The transmitter 101 and/or receiver 102 or, collectively, the transceiver 101, 102 may be suitable for fibre optic communications. The transmitter 101 and/or receiver 102 or, collectively, the transceiver 101, 102 may, therefore, have an associated bandwidth or data transfer rate. The bandwidth may be at least 10 Mbps (megabits per second), at least 100 Mbps, at least 500 Mbps, at least 1 Gbps (gigabits per second), at least 2 Gbps, at least 3 Gbps, at least 4 Gbps, at least 5 Gbps, at least 6 Gbps, at least 7 Gbps, at least 8 Gbps, at least 9 Gbps, at least 10 Gbps, at least 15 Gbps, at least Gbps, at least 30 Gbps, at least 40 Gbps, at least 50 Gbps, or at least 100 Gbps.

A variety of optical transceivers 101,102 may be suitable for use in the disclosed technology, such as for example SFP, SFP+, GBIC, X2, XENPAK, QSFP+, or CFP optical transceivers 101, 102. Such transceivers are commercially available.

The gyroscope 1 and/or system 2, optionally the optoelectronic unit 10, may include a processor 103. The processor 103 may be operably coupled to the transmitter 101 and/or receiver 102. The processor 103 may be provided as part of a complex programmable logic device. Such devices are commercially available.

The gyroscope 1 and/or system 2, optionally the optoelectronic unit 10, may include a memory 104, which may be a non-transitory computer-readable medium. The memory 104 may be operably coupled to the processor 103 and may store instructions for execution by the processor 103.

The gyroscope 1 and/or system 2, optionally the optoelectronic unit 10, may include a clock 104. The clock 104 may include an electronic oscillator. The clock and/or oscillator may have a frequency of at least 100 MHz, at least 500 MHz, at least 1 GHZ, at least 2 GHZ, at least 3 GHZ, at least 4 GHZ, or at least 5 GHz. The clock 104 may be operably coupled to any other component of the optoelectronic unit 10 such that timing information provided by the clock 104 is available for use by any other component of the optoelectronic unit 10 (e.g. the processor 103). Such clocks, or oscillators, are commercially available.

The gyroscope 1 and/or system 2, optionally the optoelectronic unit 10, may include a vernier delay line time-to-digital converter 105. The vernier delay line time-to-digital converter 105 may be operably coupled to any other component of the optoelectronic unit 10 such that timing information provided by the vernier delay line time-to-digital converter 105 is available for use by any other component of the optoelectronic unit 10 (e.g. the processor 103).

The gyroscope 1 and/or system 2, optionally the optoelectronic unit 10, may include a power source 106. The power source 106 may be operably coupled to any other component of the optoelectronic unit 10 to power that component or components.

The gyroscope 1 and/or system 2, optionally the optoelectronic unit 10, may include a connection point for connection to a power outlet to power one or more components of the optoelectronic unit 10.

The gyroscope 1 and/or system 2, optionally the optoelectronic unit 10, may include a splitter 107. The splitter 107 may be configured to split the signal transmitted by the transmitter 101. The splitter 107 may, therefore, be an optical and/or electronic splitter 107. The splitter 107 may be a 1:2 splitter, for example.

The gyroscope 1 and/or system 2, optionally the optoelectronic unit 10, may include a coupler or combiner 108. The coupler 108 may be configured to combine signals split by the splitter 107. The coupler 108 may, therefore, be an optical and/or electronic coupler 108. The coupler 108 may be a 2:1 coupler, for example.

An optical fused coupler may, therefore, be used to split and/or combine the signal. The splitter 107 and/or coupler 108 may, therefore, be an optical fused coupler. A first optical fused coupler may provide the splitter 107 and a second optical fused coupler may provide the coupler 108. Suitable optical fused couplers are commercially available, for example from Jabil Inc., Florida, USA.

The gyroscope 1 and/or system 2, optionally the optoelectronic unit 10, may include a multiplexer 109. The multiplexer 109 may be an optical and/or electrical multiplexer 109. The gyroscope 1 and/or system 2, optionally the optoelectronic unit 10, may include a demultiplexer 110. The demultiplexer 110 may be an optical and/or electrical demultiplexer 110.

Some versions of the gyroscope 1 and/or system 2, optionally the optoelectronic unit 10, may include an interferometer 111. The interferometer 111 may be configured to perform interferometry on signals (which may be optical signals) transmitted by the transmitter 101. The interferometer 111 may be operably coupled to any other component of the optoelectronic unit 10. In some versions, the gyroscope 1 and/or system 2 does not include an interferometer 111. A gyroscope 1 and/or system 2 that does not include an interferometer may provide advantages in simplicity and cost compared to systems that rely on the use of an interferometer.

It will be appreciated that each of the described components of the optoelectronic unit 10 are commercially available. The described components of the optoelectronic unit 10 may be used in the gyroscope 1 and also in the system 2. The gyroscope 1 may, therefore, include the optoelectronic unit 10 or any component thereof; likewise, the system 2 may include the optoelectronic unit 10 or any component thereof.

Any component of the optoelectronic unit 10 may be operably coupled to any other component of the optoelectronic unit 10 to facilitate the operation of the gyroscope 1 and/or system 2. The gyroscope 1 and/or system 2, and in particular the optoelectronic unit 10, may include other components to facilitate the operation of the gyroscope 1 and/or system 2, which are not described herein as they are not needed to understand the working of the described technology. Any such component will be apparent to the person skilled in the art.

The gyroscope 1 may include a path 11 (see e.g. FIGS. 1 and 2) connecting the transmitter 101 and receiver 102. Signals transmitted by the transmitter 101 may, therefore, travel along the path 11 to the receiver 102. The path 11 may include a cable, such as an electrical cable 11 or fibre optic cable 11. Optical signals, such as light pulses, may therefore travel along the fibre optic cable 11.

The path 11 may include a coiled portion (see e.g. FIGS. 1 and 2). The coiled portion may include a joined sequence of concentric rings or loops. The coiled portion may include at least 5, at least 10, at least 50, at least 100, or at least 1000 loops, for example. The coiled portion may be formed by a coil of the path medium, for example a coil of the cable 11. The coiled portion may, therefore, describe a circle. Signals traversing the coiled portion of the path 11 may, therefore, follow a path that is at least partially circular. Such signals may, therefore, be considered to exhibit clockwise or counterclockwise (i.e. anticlockwise) rotation depending on the direction of travel around the coiled portion. The gyroscope 1 may, therefore, include a coil of fibre optic cable 11 (and may be considered a fibre optic gyroscope 1). The coiled portion 11 may be defined by a laser cavity forming a loop, and the gyroscope 1 may, therefore, be considered a ring laser gyroscope 1.

The path 11 may include a first coiled portion 11a and a second coiled portion 11b (see e.g. FIG. 2). The first and second coiled portions 11a and 11b may be part of a single, continuous path 11. The first coiled portion 11a may define a first plane and the second coiled portion 11b may define a second plane. Each plane may be defined transverse to the axis of the corresponding coiled portion (i.e. coil). The first and second planes 11a, 11b may be rotationally offset with respect to each other, and may be substantially orthogonal to each other. In other words, the second plane may represent a 90° rotation of the first plane about an axis perpendicular to the axis of the coil. In use, the first plane may, therefore, be substantially horizontal, and the second plane may be substantially vertical. At a more general level, the first and second planes 11a, 11b may be rotationally offset with respect to each other by about 10-90°, about 20-90°, about 30-90°, about 40-90°, about 50-90°, about 60-90°, about 70-90°, about 75-90°, about 80-90°, about 85-90°, or about 90° (with 90° being the maximum possible offset). The first and second coiled portions 11a, 11b may be defined by two connected laser cavities in the case of a ring laser gyroscope 1.

Signals traversing the path 11 may, therefore, travel through the first coiled portion 11a and the second coiled portion 11b before reaching the receiver 102. Signals traversing the path 11 may, therefore, exhibit a first generally circular motion in the first coiled portion 11a and a second generally circular motion in the second coiled portion 11b. This may provide improved performance at different latitudes (see below). Such a gyroscope 1 may therefore be described as a two axis gyroscope 1. The two axes may be provided by a single path 11 including two coiled portions 11a, 11b. The gyroscope 1 may, therefore, have at least two axes.

In some versions the path 11 may include a third coiled portion (not shown) which may define a third plane. Signals traversing the path 11 may, therefore, travel through the first coiled portion 11a, the second coiled portion 11b, and the third coiled portion before reaching the receiver 102. The third plane may be defined transverse to the axis of the third coiled portion. The third plane may be rotationally offset with respect to the first and/or second planes. The third plane may be substantially orthogonal to the first and/or second planes. The path 11 may, therefore, include three coiled portions, each orthogonal to the other two coiled portions. In use, the first plane may be substantially horizontal, the second plane may be substantially vertical, and the third plane may be substantially vertical and orthogonal to the second plane. The gyroscope 1 may, therefore, be described as a three axis gyroscope 1. The three axes may be provided by a single path 11 including three coiled portions. These three coiled portions may be defined by three connected laser cavities in the case of a ring laser gyroscope 1.

The described path 11 including two or three coiled portions may, therefore, be used with the signal recirculation techniques described herein, and may also be used with conventional gyroscopes such as fibre optic gyroscopes and ring laser gyroscopes. Conventional optical gyroscopes measure the Sagnac effect in one plane. A three axis optical gyroscope can be provided using three separate conventional optical gyroscopes, each oriented orthogonally to the others, the results of which can be combined to provide three axis data. The path 11 described herein can therefore provide a simpler two or three axis gyroscope with fewer components compared to conventional gyroscopes by providing a single path traversing multiple planes. The described path 11 can also provide improved reliability for conventional optical gyroscopes at varying latitudes, as the optical signal may travel in substantially orthogonal planes between transmission and reception, thereby negating the effect of latitude on the Sagnac effect. Means for measuring the Sagnac effect and determining a corresponding rotation of the gyroscope are known in the art. Such gyroscopes may, therefore, use interferometry to determine rotation.

The path 11 may include a primary route and an alternative route. The primary route may include a primary coiled portion and the alternative route may include an alternative coiled portion. The primary route and alternative route may be configured such that signals traversing the primary route travel in a different direction to signals traversing the alternative route. Signals traversing the primary route may exhibit clockwise or counterclockwise rotation, and signals traversing the alternative route may exhibit the opposite rotation. In such manner, signals transmitted by the transmitter 101 may travel in both clockwise and/or counterclockwise directions. Such counterrotating signals may be used to determine a rate of rotation of the gyroscope. The primary route and alternative route may, therefore, follow the same route profile, in opposite directions. The primary route may, therefore, be described as a clockwise route, and the alternative route may be described as a counterclockwise route (or vice versa).

The primary and alternative routes may be of different lengths. For example, there may be a length difference of at least 10 m, at least 25 m, at least 50 m, at least 100 m, at least 200 m, at least 500 m, or at least 1 km between the primary and alternative routes.

The path 11 may have a length of about 50 m to 100 km, about 50 m to 75 km, about 50 m to 50 km, about 50 m to 25 km, about 50 m to 20 km, about 50 m to 15 km, about 100 m to 25 km, about 1 km to 20 km, about 5 km to 15 km, or about 10 km. The path 11 may have a length of about 500 m to 100 km, about 500 m to 75 km, about 500 m to 50 km, about 500 m to 25 km, about 500 m to km, or about 500 m to 15 km. The length may be measured from the transmitter 101 to the receiver 102 along a single route (e.g. the primary route or the alternative route in versions having both options).

The gyroscope 1 may, therefore, be a fibre optic gyroscope 1.

The gyroscope 1 may be used in a gyrocompass. The gyrocompass may, therefore, provide a heading, which can be used for navigation. The gyroscope 1 and/or gyrocompass including the gyroscope 1 may be part of an Inertial Navigation System. A gyrocompass including the gyroscope 1 is, therefore, also disclosed.

In some versions the gyroscope 1 may include a single coiled portion defining a single plane, and a system of gyroscopes 1 may be provided. Each gyroscope 1 in the system of gyroscopes 1 may operate independently of each other gyroscope 1 in the system. The gyroscopes 1 in the system may be oriented orthogonally to each other. A two axis system may therefore be provided by providing two gyroscopes 1 oriented orthogonally to each other (e.g. a first gyroscope 1 oriented horizontally and a second gyroscope 1 oriented vertically). A three axis system may be provided by providing three gyroscopes 1, each oriented orthogonally to the others. The results or output from each gyroscope 1 may therefore be combined with the results or output from the other gyroscopes 1 in the system to provide a two axis or three axis gyroscope system. The gyroscope system may be used in a gyrocompass. The gyrocompass may, therefore, combine data from each gyroscope 1 in the gyroscope system to determine a heading.

Accordingly, a single gyroscope 1 may include two or three coiled portions as described, to provide a two or three axis gyroscope, or a plurality of separate gyroscopes 1 may be provided in order to provide a two or three axis gyroscope system (i.e. two separate gyroscopes 1 for a two axis system and three separate gyroscopes 1 for a three axis system).

A two axis gyroscope 1, or system of gyroscopes 1, can be used to minimise or negate the impact of latitude and/or pitch on the reliability and accuracy of the gyroscope 1 and/or gyrocompass (e.g. by compensating for the effects of the latitude and/or pitch on the gyroscope 1 and/or gyrocompass).

A three axis gyroscope 1, or system of gyroscopes 1, can be used to minimise or negate the impact of latitude and/or pitch and/or roll on the reliability and accuracy of the gyroscope 1 and/or gyrocompass (e.g. by compensating for the effects of the latitude and/or pitch and/or roll on the gyroscope 1 and/or gyrocompass).

The gyroscope 1 may be mounted to a gimbal. Similarly, a gyrocompass including the gyroscope 1 (or system of gyroscopes 1) may be mounted to a gimbal. This may improve the accuracy and reliability of the gyroscope 1 or gyrocompass, for example by reducing the impact of vehicle roll (e.g. in a boat or aeroplane) on the gyroscope 1 or gyrocompass.

The gyroscope 1 or gyrocompass may be associated with one or more tilt sensors. The tilt sensor(s) may be used to determine one or more of pitch or roll associated with the gyroscope 1 or gyrocompass. For example, the tilt sensor(s) may determine pitch and/or roll of a vehicle in or on which the gyroscope 1 or gyrocompass is located. The output of the tilt sensor(s) may then be used to compensate for the effects of pitch and/or roll on the gyroscope 1 or gyrocompass. For example, the effect of the determined pitch and/or roll on the Sagnac effect associated with the gyroscope 1 or gyrocompass can be determined, and the results or output of the gyroscope 1 or gyrocompass can be processed to remove or reduce any contribution resulting from the determined pitch and/or roll.

Accordingly, the reliability and accuracy of the gyroscope 1 and/or gyrocompass may be improved by minimising the effect of latitude, pitch, and/or roll as described.

The system 2 may include two pairs of transmitters and receivers 101,102 connected by a path 12. The pairs of transmitters and receivers 101,102 may be provided in the optoelectronic unit 10 and the system 2 may, therefore, include a pair of optoelectronic units 10 (see e.g. FIGS. 3a and 3b). The path 12 may include an outbound portion, or first path, 12a and a return portion, or second path, 12b. The path 12 may be a linear path 12; the outbound portion 12a may be linear and the return portion 12b may be linear. The path 12 may include a cable 12 such as an electrical cable 12 or fibre optic cable 12.

The outbound and return portions may be of substantially the same length. The total length of the path 12 may be about 20 cm to 1 km. For example, more compact versions of the technology (e.g. suitable for use with relatively small vehicles such as cars, bikes, helicopters, etc.) may have a total path length of around 20 cm to 10 m (each of the outbound and return portions 12a, 12b therefore having a path length of around 10 cm to 5 m). Larger versions of the technology, for example for use on ships, may have a total path length of around 100 m to 1 km. The path may, for example, run generally from the bow to stern of a ship. It will, therefore, be appreciated that the exact path length is not essential and will vary depending on the application of the technology.

The outbound portion 12a may connect a first transmitter 101 to a first receiver 102. The return portion 12b may connect a second transmitter 101 to a second receiver 102. The first transmitter 101 and second receiver 102 may be provided as a transceiver 101,102. Likewise, the second transmitter 101 and first receiver 102 may be provided as a transceiver 101,102. The path 12 may, therefore, connect a pair of transceivers 101, 102.

The outbound portion 12a may have a first signal propagation speed and the return portion 12b may have a second signal propagation speed (which may be different to the first signal propagation speed). For example, the outbound portion 12a may include a first fibre optic cable having a first propagation speed and the return portion 12b may include a second fibre optic cable having a second propagation speed different to the first propagation speed.

In some versions one or both of the outbound 12a or return 12b portions may include an extension section 13 (see e.g. FIG. 3b). The extension section 13 may include a helical, coiled, or spiral section of path 12. The extension section 13 may, therefore, extend the length of the corresponding portion 12a, 12b of the path 12. In some versions only one of the outbound or return portions 12a, 12b may include an extension section 13; however, in some versions both portions 12a, 12b may include an extension section 13, but those extension sections may be of different lengths. The extension section or sections 13 may, therefore, cause a path length difference between the outbound and return portions 12a, 12b of the path 12, although the linear distance covered by the outbound and return portions 12a, 12b may be the same.

Accordingly, the extension section or sections 13 may cause a difference in signal travel time in the outbound portion 12a compared to the return portion 12b. This difference may be used to determine a linear velocity of the system 2 in an analogous manner to the versions of the system 2 using outbound and return portions 12a, 12b having different signal propagation speeds. In some versions the extension section 13 may be used in addition to the different propagation speeds between the portions 12a, 12b, while in other versions the extension section 13 may be used with portions 12a, 12b that have identical signal propagation speeds (e.g. because they are made of the same medium such as the same fibre optic cable).

Each of the outbound 12a and return 12b portions may, therefore, have a baseline signal travel time, which may be defined as the expected signal travel time from one end of the portion to the other, or equivalently, from the corresponding transmitter at one end of the portion to the corresponding receiver at the other end of the portion. The baseline signal travel time may be defined as an expected signal travel time in the absence of any external influences (such as linear velocity) or under a set of predefined conditions (which may include a known linear velocity, for example). The baseline signal travel time may, therefore, correspond to the signal travel time when the system 2 is stationary (e.g. at a stationary point on Earth).

The outbound and return portions 12a, 12b may have different baseline signal travel times. In other words, a signal transmitted through the outbound portion 12a may take a different amount of time to arrive at its corresponding receiver compared to a signal transmitted through the return portion 12b to its corresponding receiver. This time difference may be due to the outbound and return portions 12a, 12b having different signal propagation speeds and/or path lengths as described. The different baseline signal travel times may cause an observable Sagnac effect in the system 2, from which the linear velocity can be determined.

The operation of the gyroscope 1 will now be described. The gyroscope 1 may use signal recirculation to provide rotation information with relatively simple and inexpensive equipment. For example, the gyroscope 1 may not include an interferometer. The recirculation of the signal may enable the functioning of the gyroscope 1 without an interferometer.

In use, a signal is transmitted from the transmitter 101 to the receiver 102 along the path 11. The time of the first signal transmission may define the start of a sample period.

The sample period may be at least 25 μs, at least 50 μs, at least 0.1 ms, at least 1 ms, at least 2 ms, at least 5 ms, at least 10 ms, or at least 20 ms. This corresponds to an update rate of 40,000 Hz or less, 20,000 Hz or less, 10,000 Hz or less, 1000 Hz or less, 500 Hz or less, 200 Hz or less, 100 Hz or less, or 50 Hz or less. In some versions the sample period may be predefined. The sample period may, therefore, be set before the transmission of the first signal by the transmitter 101. In other versions a dynamic sample period may be used. The dynamic sample period may be set by a user. For example, a user may interact with the gyroscope 1 to initiate the start of the sample period (e.g. by interacting with a user interface associated with the gyroscope 1). The user may interact with the gyroscope 1 to trigger the end of the sample period (e.g. by interacting with the user interface associated with the gyroscope 1).

The signal may travel along the path 11 to the receiver 102. The transmitter 101 and receiver 102 may be configured such that reception of the signal at the receiver 102 causes the transmitter 101 to retransmit the signal. In other words, the transmitter 101 may be configured to retransmit the signal in response to the signal being received at the receiver 102 throughout the sample period. The transmitter 101 and receiver 102 may, therefore, be configured to recirculate the signal during the sample period. The recirculation may end when the sample period ends.

The processor 103 may be configured to determine the time between the first signal transmission and the reception of the final retransmitted signal when the sample period has ended. The processor 103 may be further configured to use the time between the first signal transmission and the reception of the final retransmitted signal to determine a corresponding rotation of the gyroscope 1 over the sample period.

The gyroscope 1 may use the Sagnac effect to determine the rate of rotation.

In some versions, a single (i.e. only one) signal is transmitted by the transmitter 101. The signal is not split, and so a single (i.e. only one) signal is received at the receiver 102. This single signal is then recirculated by the transmitter 101 and receiver 102 along the path 11 throughout the sample period. When the sample period has ended, the time of reception of the final retransmitted signal can be determined, for example using the clock 104 or vernier delay line time-to-digital converter 105. The time between the first signal transmission and the reception of the final retransmitted signal can then be used to determine a corresponding rotation of the gyroscope 1 over the sample period.

In such versions, the expected time of arrival of the signal at the receiver 102 can be determined. For example, the expected time of arrival following the first signal transmission can be determined based on the path length, propagation speed, and/or temperature. Alternatively, the expected time of arrival can be determined in a calibration phase. In the calibration phase, the gyroscope 1 may not be rotating or may be rotating at a known or predetermined rate. The expected time may therefore also be referred to as a calibration time.

The expected delay involved in the retransmission of the signal can also be determined. The expected retransmission delay can be determined based on the specifications of the transmitter 101 and receiver 102, or transceiver 101,102. For example, the transmitter 101 and receiver 102, or transceiver 101,102, response time can be estimated based on the data rate specified for the transmitter 101 and receiver 102, or transceiver 101,102. A 10 Gbps optical transceiver, for example, can be estimated to have a maximum response time of 100 ps. There are various options for determining the average response time. A simple implementation would be to model the average response time as half of the maximum response time, for example 50 ps for a 10 Gbps transceiver 101,102. Other possibilities are described in the worked example below. The expected retransmission delay per iteration of the signal recirculation can, therefore, be determined.

The expected duration of one iteration of signal recirculation can therefore be determined.

The expected time of arrival of the final retransmitted signal for any sample period can therefore be determined based on the expected number of iterations of recirculation for that sample period. The expected values may be based on no rotation of the gyroscope 1 or rotation of the gyroscope 1 at a predefined rate. The particular rotation rate chosen for the expected values or calibration is not essential.

The actual time between the first signal transmission and the reception of the final retransmitted signal can be compared to the expected time to determine the rate of rotation of the gyroscope 1. The Sagnac effect can be used to determine the rate of rotation.

In other words, the expected time between the first signal transmission and the reception of the final retransmitted signal is a predetermined time that would be taken if the gyroscope 1 were rotating at a predetermined rate. Therefore, by determining the difference between the expected time and the determined time, the rotation of the gyroscope 1 can be determined. For example, if the determined time is equal to the expected time, then the gyroscope 1 may be rotating at the predetermined rate. The expected time therefore depends on the chosen sample period. The expected time for any sample period can be calculated based on the gyroscope characteristics, such as the path length, propagation speed, and/or temperature.

In some versions counterrotating signals are transmitted by the transmitter 101 and recirculated during the sample period.

In some versions counterrotating signals may be transmitted simultaneously by the transmitter 101. The receiver 102 may, therefore, receive two signals from the transmitter 101. The signals may be representative of a clockwise signal and a counterclockwise signal. In such versions, the path 11 may include the primary and alternative path described previously. The same transmitter 101 and receiver 102 or transceiver 101,102 may be used for both signals. The transmitter 101 may, therefore, transmit a single (i.e. only one) signal, which may be split by the splitter 107. A part of the signal may traverse the primary route and a part of the signal may traverse the alternative route. The split signals may each be directed by the coupler 108 to the same receiver 102. The signals may, therefore, arrive at the receiver 102 at different times.

The gyroscope 1 may be configured for alternating clockwise and counterclockwise signals to be transmitted to the receiver 102, for example using the splitter 107 and coupler 108 or multiplexer 109 and demultiplexer 110.

The transmitter 101 may be configured to transmit a second signal a predetermined time after the first signal. The second signal may be transmitted before the first signal is received at the receiver 102. The first and second signals may be distinguishable.

For example, the transmitter may be configured to transmit a first signal, which may traverse the primary route (e.g. including a clockwise coiled portion). While the first signal is traversing the primary route, the transmitter 101 may transmit a second signal, which may traverse the alternative route. The receiver 102 may, therefore, receive the first signal at a first time and the second signal at a second time, each of which can then be recirculated by the transmitter 101. The signals may, therefore, be alternately routed along the primary and alternative routes, in other words, to provide alternate clockwise and counterclockwise signals. The signals may be distinguished by their arrival times at the receiver 102 and/or by a unique characteristic of each signal.

The first and second signals may be distinguishable, for example they may be optical signals transmitted at different wavelengths. In some versions both signals may traverse both routes, but the optoelectronic unit 10 may be configured such that one of the received signals from the first signal transmission is ignored (i.e. not retransmitted and not used to determine rotation) and one of the received signals from the second signal transmission is ignored (e.g. using the multiplexer 109 and demultiplexer 110). For example, the optoelectronic unit 10 may be configured such that only the first received signal from the first signal is retransmitted per iteration and only the second received signal from the second signal is retransmitted per iteration. In such a manner, a simple splitter 107 and coupler 108 can be used to provide counterrotating signals for use in determining the rate of rotation of the gyroscope 1.

In some versions, the gyroscope 1 may be configured to use signal recirculation information corresponding to the primary route in a first sample period and to use signal recirculation information corresponding to the alternative route in a second sample period, to determine a rate of rotation of the gyroscope 1. For example, the gyroscope 1 may include the primary and alternative routes, and the splitter 107 and coupler 108. Each transmitted signal from the transmitter 101 may, therefore, result in two received signals at the receiver 102, due to the split path. In a first sample period, the gyroscope 1 may be configured to recirculate only the first received signal in each iteration of signal recirculation. This may correspond to a clockwise signal, for example. In a second sample period, the gyroscope 1 may be configured to recirculate only the second received signal in each iteration of signal recirculation. This may correspond to a counterclockwise signal, for example. The gyroscope 1 may, therefore, provide a simple apparatus for generating counterrotating signals for use in determining a rate of rotation.

In versions configured to use counterrotating signals, the time of reception of the final retransmission of the first signal may be compared to the time of reception of the final retransmission of the second signal to determine the rate of rotation of the gyroscope 1. The Sagnac effect may, therefore, be used to determine the rate of rotation of the gyroscope 1. For example, if there is a fixed delay between the sending of the first and second signals, it would be expected that the signals would arrive at the receiver 102 with the same fixed delay at the end of the sample period. Any variation in the delay between signals can be used to determine a corresponding rotation using the Sagnac effect. Similarly, if the signals are transmitted simultaneously but one route is longer than the other (e.g. the primary route is longer than the secondary route), the signals would be expected to arrive at the receiver 102 with a corresponding delay proportional to the length difference.

Versions using the described two or three axis gyroscope 1 may operate using the same principle. In such versions the path includes multiple coiled portions in different planes as described. The calculations used to determine the rate of rotation are therefore adjusted accordingly.

In general, multiple sets of iterations through the coil can be combined to give better accuracy. So, if two iterations are combined, a better accuracy is obtained for the mean heading over a 0.1 s period, rather than a 0.05 s period, for example. This also means that if the coil length limits the number of iterations that can be used (i.e. the period over which the heading is derived), it is possible to re-start from zero whilst keeping the first set of iterations in memory to be added when the second set finishes. The operation of the gyroscope 1 may, therefore, include recording a first signal delay corresponding to a first recirculated signal, recording a second signal delay corresponding to a second recirculated signal, combining the first and second signal delays, and using the combined signal delay to determine the rate of rotation. The delay may be recorded in memory 104.

The sample period may, therefore, include a threshold period, at which the transmitter 101 and/or receiver 102 and/or transceiver 101,102 is configured to stop recirculating a first sub-signal and to begin recirculating a second sub-signal. The threshold period may be calculated based on the expected maximum delay corresponding to the path length and expected rates of rotation. The threshold period may correspond to a period at which a plurality of transmitted signals are expected to overlap, for example for a predefined rate of rotation. The threshold period may, therefore, be used to prevent overlap of clockwise and counterclockwise signals.

The operation of the system 2 for determining linear velocity will now be described.

In use, the first transmitter 101 may transmit a signal along the outbound portion 12a of the path 12 to the first receiver 102. The time of the first signal transmission defines the start of a sample period as above.

The second transmitter 101 may be configured to retransmit the signal along the return portion 12b of the path 12 to the second receiver 102 in response to the signal being received at the first receiver 102 throughout the sample period.

The first transmitter 101 may be configured to retransmit the signal along the outbound portion 12a of the path 12 to the first receiver 102 in response to the signal being received at the second receiver 102 throughout the sample period.

The system 2 may, therefore, be configured to recirculate the signal throughout the sample period. The signal recirculation may end when the sample period ends.

When the sample period has ended, the processor 103 may be configured to determine the time between the first signal transmission and the reception of the final retransmitted signal at the second receiver 102. The processor 103 may be configured to use this determined time to determine a corresponding linear velocity of the system 2 over the sample period. The Sagnac effect may be used to determine the linear velocity. In some versions, the processor 103 may be configured to use the time of reception of the final retransmitted signal at the first receiver 102 to determine the linear velocity.

The linear velocity may be determined by comparing the determined time between the first signal transmission and the reception of the final retransmitted signal at the first or second receiver 102 to an expected time.

The expected time of arrival of the signal at the first and/or second receiver 102 can be determined. For example, the expected time of arrival following the first signal transmission can be determined based on the path length, propagation speed, and/or temperature. Alternatively, the expected time of arrival can be determined in a calibration phase.

The expected delay involved in the retransmission of the signal can also be determined. The expected retransmission delay can be determined based on the specifications of the transmitter 101 and receiver 102, or transceiver 101,102. For example, the transmitter 101 and receiver 102, or transceiver 101,102, response time can be estimated based on the data rate specified for the transmitter 101 and receiver 102, or transceiver 101, 102. A 10 Gbps optical transceiver, for example, can be estimated to have a maximum response time of 100 ps. There are various options for determining the average response time. A simple implementation would be to model the average response time as half of the maximum response time, for example 50 ps for a 10 Gbps transceiver 101,102. Other possibilities are described in the worked example below. The expected retransmission delay per iteration of the signal recirculation can, therefore, be determined (for each transmitter 101 and receiver 102, or transceiver 101, 102).

The expected duration of one iteration of signal recirculation can therefore be determined.

The expected time of arrival of the final retransmitted signal (at the first or second receiver 102) for any sample period can therefore be determined based on the expected number of iterations of recirculation for that sample period. The expected values may be based on the system 2 being stationary, for example, or moving at a predefined linear velocity. The exact velocity chosen for the expected values or calibration is not essential.

Accordingly, by comparing the actual time to the expected time, the linear velocity of the system 2 can be determined. The difference between the actual and expected times can be attributed to the Sagnac effect, thereby enabling linear velocity to be determined.

The system 2 may cause an observable Sagnac effect due to the different travel times of the signals through the outbound 12a and return 12b portions of the path 12, which may result from the different propagation speeds and/or extension section(s) 13 in the outbound 12a and return 12b portions. As described previously, the outbound 12a and return 12b portions of the path 12 may have different baseline signal travel times.

### Worked Example

A worked example is provided to aid understanding. The worked example is based on a fibre optic implementation of the gyroscope 1 and system 2, but other implementations are possible.

The time taken for a signal from the transmitter 101 to propagate along the path 11 to the receiver 102 is fixed by the distance between the transmitter 101 and receiver 102, regardless of the motion of the transmitter 101 and receiver 102. If the transmitter 101 and receiver 102 are fixed relative to each other, and the signal between them follows a (partially) circular path 11, then if the gyroscope 1 is rotated in the direction of propagation while the signal is in transit, the path length increases or decreases (depending on the direction of rotation), so the time of flight increases or decreases by a corresponding amount. The path length change is proportional to the angular velocity of rotation of the gyroscope 1, and to the radius of the circular path 11 followed by the signal.

Fibre optic gyrocompasses (FOGs) use the Sagnac effect to determine a path length difference between clockwise and counter-clockwise optical signals propagated through an optical fibre coil, typically several kilometres long. The magnitude of the path length difference produced by the Sagnac effect is proportional to the rate of rotation, and is small for low rates (e.g., the earth's speed of rotation: 11.6057 micro-rotations per second, or 1.8471 micro-radians per second).

Existing FOGs use interferometry to measure the very small path length difference between the clockwise and counter-clockwise optical signals. Each light pulse travels the length of the coil once, so the total path length change is limited by the time taken to complete this journey. The path length change in metres, δ, is defined to be:

$$δ = Ω {Rt}_{p}$$

where:
tₚ is the time taken for the light to propagate through the coil, in seconds;
Ω is the rate of rotation of the instrument in the plane of the coil (i.e. the rotation to be measured), in radians per second; and
R is the radius of the coil, in metres.

The propagation time, tₚ, depends on the coil's length, i.e. its radius and number of turns:

$${t}_{p} = \frac{2 π RN}{v}$$

where:
v is the speed of propagation of the light pulse through the fibre coil in metres per second; and
N is the number of turns in the coil.

Therefore, the path length change in metres for a pulse propagated through the coil is:

$$δ = \frac{2 π RN \cdot Ω R}{v}$$

FOGs can have a coil of up to 5 km of optical fibre, through which a pulse of laser light is transmitted—in both clockwise and counter-clockwise directions simultaneously. When the pulse reaches the end of the coil, the Sagnac effect means that, unless the axis of the coil (i.e. the axis orthogonal to the plane of the coil) is pointing exactly east-west, there will be a difference in time of arrival of the pulses that travelled in the clockwise and counter clockwise directions. That time difference is typically small, because the time taken for light to propagate through the coil is short: for a 5 km coil length, (i.e., 2πRN=5000), for optical fibre propagation at 2×10⁸ m/s (i.e., ⅔ of the speed of light in a vacuum), tₚ would be 25.0 μs. Consequently, optical interferometry is used to observe the Sagnac effect (which is expensive due to the highly sophisticated and complex equipment required).

The disclosed technology provides a gyroscope 1, that can be used in a gyrocompass, with cheaper, less sophisticated equipment.

In the disclosed technology, high data-rate optical communications hardware can be used to transmit and receive the optical signals, which can be propagated through an optical fibre coil 11 (e.g. for a fibre optic gyroscope 1).

The communications hardware can be capable of data rates of 10 Gigabits per second (or more), propagated as one or more cycles of a square wave. This communications hardware is cheap, reliable, and readily available.

In the disclosed technology, the optical signal can be recirculated around the path 11 (e.g. fibre optic coil) by using the transmitter 101 and receiver 102 as a repeater for the optical signal. The signal may therefore recirculate around the path 11 multiple times between readings. The Sagnac effect causes the optical pulse to arrive a bit sooner, or a bit later (depending on the direction of the pulse's propagation—clockwise or counter clockwise) on each iteration around the path 11 (e.g. through the coil 11).

The effect of recirculation of the pulse in this way is that the Sagnac change in pulse arrival time becomes independent of the coil length, and depends only on the total time that the signal is propagated and recirculated. As before, but ty is now the total propagation/recirculation time (i.e. the interval between heading estimates being made). Typically, this might be 0.01 seconds or more (compared with the 50 us for a typical FOG). Thus, the effect of recirculation is to increase the size of the Sagnac path length change, 8.

It may be expected that the jitter associated with the electronics of the transceiver mechanism could obscure the Sagnac effect in a recirculating optical gyroscope. However, due to the large number of repetitions and the statistical nature of the jitter (which can be assumed to be normally distributed), the Sagnac effect remains visible.

The receive and transmit operations within the transmitter 101 and receiver 102, which may be provided as a transceiver 101,102, take a very small proportion of the time between heading updates—for example, for a 10 Gbps transceiver with 1000 m coils, the time spent in the coil for each iteration is 1000/2×10⁸=5 μs, while the transceiver takes up to 100 ps—so in this instance, 100×10⁻¹²/5×10⁻⁶=2×10⁻⁵ of the time is spent in the transceiver 101,102. So, the Sagnac effect during each pass through the coil will be 99.998% of the Sagnac effect without the transceiver 101,102.

The Sagnac pulse length change can be detected by measuring the time difference between the arrival of the pulse P in each direction (clockwise and counter clockwise), where P (the number of recirculations carried out by the transceiver 101,102) is defined by the update period required.

Due to the larger pulse delay change resulting from recirculation of the pulse, interferometry is not necessary to determine that change, allowing the instrument to be much cheaper than a conventional FOG to produce.

Because this approach uses recirculation, the effective optical path length is unlimited. The system does not need to use interferometry, meaning low-cost optical and logic circuit elements can be used.

For fibre optic implementations, accuracy is proportional to coil length, with a longer coil leading to more accurate measurements. The coil length may be between 50 m and 25 km. A 10 km coil with a mean diameter of 10 cm can form a hoop with cross-sectional diameter of 2.3 cm.

Rather than a 5 km coil pulse travel distance, as used in conventional FOGs, the described recirculating optical gyroscope (used in a gyrocompass) can use the maximum possible time for the light pulse to circle around the coil between measurements; for a 20 Hz heading update rate, that is 0.05 seconds that the light pulse spends recirculating in the coil; and for a 200 Hz update rate, that is 0.005 seconds.

A coil length of 10 km (a standard range capability for cheap fibre transceivers) is considered as an example. For a 20 Hz update rate, the pulse will travel through the 10 km coil 1000 times, and for a 200 Hz update rate, 100 times. Higher accuracy can be achieved with a longer coil, as the jitter due to the transceiver 101,102 at the coil end will have a smaller influence on longer coils.

The Sagnac effect due to the Earth's rotation causes light's travel time through a coil to change by a maximum of 11.6057 μs per second (if the axis of the coil is aligned with true north or south) and by a minimum of 0 μs per second (if the axis of the coil is aligned east or west). Accordingly, there is a shift of 0.12895 μs (as 11.6057/90=0.12895 μs) per second per degree of heading, which is 128.95 ns per second per degree.

The arrival time of the transmitted optical signal (i.e. light pulse) can be measured to an accuracy of 0.25 ns by using a 4 GHz oscillator, for example. Measuring the arrival time to an accuracy of ¼ of a nanosecond corresponds to a heading accuracy of 0.001939° per second (1/(4*128.95)=1/514=0.001939° per second). The disclosed technology can therefore deliver, for example, 0.001939° heading accuracy (relative to true north) if updating at 1 second intervals, or 0.03878° at 0.05 second intervals (20 Hz), or 0.3878° accuracy at 0.005 second update intervals (200 Hz).

Improving the time delay measurement accuracy (e.g. by using a digital vernier mechanism) can improve the accuracy of the heading measurement, because the limit on heading accuracy is the variance of the jitter the pulse was subjected to in the transceiver 101,102. Therefore, another option for increasing heading accuracy is to use a higher data rate transceiver 101,102 (because its worst-case jitter will be lower)—100 Gbps transceivers, for example, would provide higher accuracy than a 10 Gbps transceiver 101,102.

The described examples focus on fibre optics as the mechanism for obtaining the Sagnac effect; however, the Sagnac effect would also be present in correctly built electrically wired systems. Other versions could, therefore, use electrical signals rather than optical signals.

The recirculating mechanism for measuring Sagnac effect could be used for optical gyroscopes that are not being used as compasses, but are only intended to measure rotations about an axis of the system on which they are mounted. This would enable very accurate measurement of the rate of rotation at low cost. This could form the rate gyro aspect of an Inertial Navigation System in which the recirculating optical gyroscope was present, for example, further simplifying and reducing the overall cost of an Inertial Navigation System.

The heading data obtained over the sample period (e.g. after 1/20th or 1/200th of a second) would be the mean heading over that period. For a moving system, therefore, the determined heading would not be an ‘instantaneous’ heading, but the mean heading over a given period. The recirculation could therefore be carried out over longer periods, to give a more useful mean heading. For example, if an Autonomous Underwater Vehicle is in a known location at the start of a sample period, then travels on a known heading, the actual mean heading steered over the sample period (i.e. the time for which it held that course) can be measured. This allows an Inertial Navigation System's dead reckoning to be more accurate, as the actual mean heading steered for a given period can be known. Depending on the heading steered and the fibre coil length, it may be necessary to ‘reset’ the offset between clockwise and counter-clockwise signals periodically, to ensure pulse overlaps between clockwise and counter clockwise pules are avoided.

### Latitude Independence

The described gyroscope 1 may have both vertical and horizontal fibre coil pairs, with their axes in the same plane (i.e., the coil has been rotated through 90° orthogonal to its axis). A “coil pair” means a clockwise coil and a counterclockwise coil. As explained earlier, a vertical coil pair (clockwise and counter clockwise) at the equator experiences the full Sagnac effect. But at the north or south pole, there is no Sagnac effect for a vertical coil-only horizontal coils are subject to the Sagnac effect. The performance of conventional FOGs degrades as the latitude at which it is being used increases, north or south. FOG heading accuracy is multiplied by ‘secant latitude’, i.e., 1/cosine (latitude), so they have their best possible performance at the equator, but their heading accuracy degrades if the device is used closer to either pole. If two pairs of coils at 90° are used in a gyrocompass, that means that the device provides the same accuracy of heading information at any latitude. Note that this version produces only half the Sagnac effect that would be expected from a vertical coil at the equator (or a horizontal coil at a pole), because half the time spent in the twin coils produces no Sagnac effect. But that half-Sagnac-effect will be present at any latitude; and the recirculation process increases the time delay produced by the Sagnac effect, so the two pairs of coils can still give usefully accurate heading information.

This two-pairs-of-coils mechanism could be used on conventional FOGs, though the fibre length would have to be doubled to obtain the current Sagnac effect at the equator or pole—but this magnitude of Sagnac effect would be present at any latitude. The coils are referred to as ‘vertical’ and ‘horizontal’ coils, but the important aspect is that there is 90° between their axes—it does not matter if neither coil is exactly vertical or horizontal. An angle of less or greater than 90° between the coils would also work, but give poorer accuracy than the 90° angle would.

### Linear Speed Measurement

The Sagnac effect also applies to linear motion. So, again, rather than restricting the effect to that obtained from a given length of optical fibre, it is possible to use recirculation of the signal. However, if the light/signal velocity is the same in both directions, there will be no useful ‘difference’ information to base the velocity estimate on. So, to obtain useful information, one fibre or wire with signal propagation at ‘low’ speed (e.g. 0.6c) running in a straight line for e.g. 1 m can be used, with a receiver/transmitter 101,102 at the end passing the signal to another wire which moves the signal at ‘high’ speed (e.g. 0.9c) running back to the original transceiver 101,102, in a straight line; then a Sagnac effect is produced for which a formula can be written. By retransmitting the signal in response to receiving at the corresponding receiver, a pair of wires can give a significant effect.

The measured return travel time, tᵣ, is:

$${t}_{r} = {t}_{b} + {t}_{f}$$

where:
t_{f} is the time to travel linearly forwards at a velocity of c_{f}, and is:

$${t}_{f} = \frac{l + v {t}_{f}}{{c}_{f}}$$

t_{b} time to travel linearly backwards at a velocity of cp, and is:

$${t}_{b} = \frac{l - v {t}_{b}}{{c}_{b}}$$

l=length in metres of the fibre line forwards and backwards, and
v=linear velocity in the direction of the fibre line.

This results in three equations with three unknowns (v, tₚ, t_{f}); c_{f}, c_{b} and l are known, and tᵣ has been measured. So, these equations can straightforwardly be solved for v, the linear velocity to be determined.

Additionally or alternatively to using fibres with different propagation speeds, linear velocity may be determined using paths of different lengths. For example, a first fibre may be a straight fibre running from a transmitter to a corresponding receiver, whereas a second fibre may include an extension section, such as a helical, coiled, or spiral section. The effect of the extension section is that the fibre is extended such that the time taken for a light signal to traverse the fibre is also extended. Both the outbound and return fibres may include an extension section but those extension sections may be of different lengths, for example both fibres may include a spiral portion, but the spiral portions may be of different lengths. The transmitted signal may, therefore, spend more time in the longer fibre, such that a Sagnac effect is produced that can be used to determine linear velocity.

The estimate of linear velocity can be improved by using recirculation; effectively, both ends of the length of fibre or wire perform recirculation, but only one end collects timing information.

The concept is also applicable to independent linear speed measurement in x, y and z directions.

The speed measured is relative to being stationary in the universe, so the motions of the Earth, the Sun and the galaxy will affect the velocity measurements obtained.

### Fibre Mass and Bulk

10 km, used as an example above, is a practical coil length-using 125 μm diameter single mode fibre would make a 10 cm diameter coil with 33,333 turns of the fibre (which has a surface area per fibre of 1.227×10⁻⁸ m²), giving the optical fibre hoop of the coil a cross-section diameter of 2.3 cm.

125 μm diameter fibre can have a mass of 1.8 g cm³, or 1800 kg m⁻³. 125 μm diameter fibre can have a volume of 1.2272×10⁻⁸ m³ per metre of fibre, so a mass of 22.1 μg per metre of fibre. That is 22.1 mg per km of fibre, and 0.221 kg for 10 km of fibre. Such fibres are commercially available.

When using two coils arranged at 90° to each other to avoid the secant latitude problem, the coil mass and coil area is doubled, to obtain a given heading resolution.

### Measurement Accuracy

In general, multiple sets of iterations through the coil can be combined to give better accuracy. So, if two iterations are combined, a better accuracy is obtained for the mean heading over a 0.1 s period, rather than a 0.05 s period, for example. This also means that if the coil length limits the number of iterations that can be used (i.e. the period over which the heading is derived), it is possible to re-start from zero whilst keeping the first set of iterations in memory to be added when the second set finishes.

An optimal pulse length would ensure that after the required number of iterations, the pulse has not been eroded by the transceiver's leading-edge jitter to the point where it ceases to exist.

For example, the transceiver's bandwidth can be used as a reasonable basis for an estimate of its worst-case leading-edge jitter (e.g. 100 ps jitter for a 10 GHz transceiver 101,102). That implies that for a given number of iterations, P, the starting pulse length would preferably be P×100 ps; such as 2500×100 ps for 2500 iterations, or 250 ns. After that 250 ns pulse, a gap long enough for the delayed pulse to reach the receiver 102 is required (delayed by the longer path length on the other fibre coil). Trailing-edge jitter of the pulse should also be accounted for. Again, the worst-case assumption is that the jitter equals the response time-so 100 ps for the trailing-edge jitter, too. This leads to a 500 ps pulse with a 500 ns blank period after it, allowing for the leading- and trailing-edge jitter. There would then be another 500 ns blank period, during which the delayed pulse would arrive; again, this would be followed by 500 ns to allow for trailing edge jitter. This would, therefore, involve transmitting a 500 ns pulse followed by 1500 ns of blank. That is a 25% duty cycle, 500 kHz signal.

The per-iteration Sagnac effect is small (typically in the order of picoseconds—for a 1 km coil, time to travel coil length is 1000/2×10⁸=5×10⁻⁶ s, during which the Sagnac effect is (11.60×10⁻⁶)×(5×10⁻⁶)=5.8×10⁻¹¹ s, or 58 ps per iteration) and its worst-case can easily be calculated based on the fibre length, and added to the pulse length, along with the jitter expected. If a sequence of the minimum-length pulses is initially transmitted, then the receiver will receive the pulse from the shorter fibre, then, after a short delay, the pulse from the longer fibre. Depending on whether the clockwise or counter-clockwise pulse is being processed, the shorter or longer fibre's pulse will be re-transmitted, or ignored.

### Measuring the Sagnac Delay

There are multiple options for determining the Sagnac delay on a pulse at the end of the recirculation iterations, and measuring the heading from that. One option is to transmit the pulse on clockwise and counter clockwise fibre coils, then measure the difference between their arrival times.

Another other option is to measure the Sagnac effect on a single clockwise or counter clockwise coil, by comparing the pulse arrival time with that expected when the coil's axis is pointing east or west at the temperature the device is experiencing.

### Simultaneous Clockwise and Counter-Clockwise Pulses

If there are two coils (with opposite directions of propagation) operating simultaneously, they can share the same transceiver 101,102, so the total jitter experienced by each coil would be very similar. To allow one transceiver's laser output to reach both coils, an optical 1:2 splitter 107 can be used. When the laser pulse reaches the end of the coil, a 2:1 optical combiner 108 can be used to route both the clockwise (CW) and counter-clockwise (CCW) pulses to the transceiver's receiver.

If the coils are the same length, their pulses will arrive at the receiver 102 at the same, or very similar, times. The CW and CCW coils can, therefore, be of different length so that their pulses arrive at the receiver 102 at distinguishably different times. The optimal pulse length depends on the worst-case jitter from the transceiver's receiver 102, multiplied by the number of iterations through the coil. For a 10 Gbps transceiver 101,102, that worst-case leading-edge jitter is 100 ps; and for a 1000 m coil and a 20 Hz update rate, 1000/2×10⁸=20 μs per iteration is preferred, and ( 1/20)/20×10⁻⁶=2500 iterations. In that case, the pulse length would preferably be greater than 2500×100 ps=250 ns. Therefore, for the CW and CCW pulses to arrive at the receiver separately, the timing difference would preferably be greater than 250 ns, or giving a fibre length difference greater than (250×10⁻⁹ s)×(2×10⁸ m/s)=50 m. The same is true of the trailing-edge jitter—it would have a 50 m length difference, too. So, it would make sense to have the CW coil more than 100 m longer than the CCW coil, for this example.

The use of different length coils to allow signals to be identified by their arrival time is a method that could be replaced by using an optical multiplexer to ensure that the pulse is only propagated in the desired direction, rather than both directions. The different coil lengths mechanism is proposed because currently optical multiplexing is expensive and bulky; however, this is expected to improve in future.

In operation, the CW and CCW signals should preferably be separated by a long enough time to ensure that the worst-case Sagnac effect will not cause them to overlap. From the Earth's rotation, the largest possible Sagnac effect per coil is 11.6057 μs per second, so for two coils at a 20 Hz update rate it is 2×(11.6057×10⁻⁶)/20=1.16057 μs per update, or (1.16057×10⁻⁶ s)×(2×10⁸ m/s)=232.1 m. A 4 GHz clock can be used to set that interval between the CW and CCW transmissions. Although both transmissions are received at the transceiver's receiver 102, they are distinguishable by their time of arrival, relative to the transmission time-because it is known that one coil is longer than the other. The electronic multiplexer 109, which allows the received pulse's electrical signal to be passed on to the transceiver's transmitter 101, can be set to redirect the pulse that is not of interest so that it does not reach the transmitter 101 for recirculation.

The timings derived above imply that the signal initially passed into the transceiver 101, 102 by a complex programmable logical device (CPLD) can be a square wave of 25% duty cycle with a period of at least 2000 ns, or a frequency of less than 500 kHz. That frequency can be passed into the transmitter, initially, for a limited time period, which can be stopped before the pulse signal for the opposite direction appears at the receiver. For a 1 km fibre, the time for the signal to reach halfway along the fibre is 500/2×10⁻⁸=2.5 μs, so only one cycle of that clock can be passed from the CPLD to the transmitter 101 at the start of the update. A 10 km fibre would allow ten such pulses to be used, and a higher bandwidth transceiver 101,102 would allow still more pulses; more pulses give better accuracy of the heading estimate, as the average of all the pulses time offsets is used to calculate the heading.

Interferometry may be used along with recirculation when high update rates are required. This use of interferometry would result in higher heading accuracy than that obtained from conventional FOGs, because of the extra Sagnac effect due to recirculation.

### Single-Direction Only

The technology could use one coil, which can be CW or CCW, which can be calibrated with axis facing east/west at various temperatures. For example, there could be one coil for each of the 90° coil locations, rather than both CW and CCW coils.

It is preferable to have two coils at 90° to each other for the Single Direction version, as this means that the maximum Sagnac effect would always be ±11.6057 μs per second (regardless of latitude), so the actual time difference obtained can be used to determine heading angle. When calibrated for zero Sagnac effect when the axis is pointing east-west, the time difference is calculated relative to that value at a given temperature; however, the actual average jitter may vary with temperature.

Like the two-pairs-of-coils system, the two-single-coils system can use an electronic 2:1 multiplexer device to start off transmitting a signal from electronics, then continue by re-transmitting the received signal.

### Implementation

Assuming that the optical receive and transmit process takes exactly the same time for every loop iteration, then the 0.001939 degrees per second accuracy derived earlier would be achieved. In reality, the receive and transmit processes may take variable amounts of time, as there is leading-edge and trailing-edge jitter.

It can be assumed that the receive and transmit responses each follow a normal distribution. For normal distributions, 68.2% of samples are within ±1 standard deviations from the mean, with 95.4% of samples within ±2 standard deviations and 99.7% of samples within ±3 standard deviations. This continues for ±4 standard deviations-only 1 in 31,574 samples outside this range; ±5 standard deviations-only 1 in 3.488 million samples outside this range; ±6 standard deviations−1 in a billion samples outside this range; while none exceed ±8 standard deviations. The standard Bit Error Rate for fibre communications is 1 in 1000 billion, so ±7 standard deviations.

The response of the transmitter and receiver can be considered to cover ±7 standard deviations—the transmitter cannot react before an event has happened, and it will not take longer than its specification defines, ever, regardless of within-specification operating temperature. For a 10 Gbps Ethernet laser transceiver, for example, that means it responds in less than 1/10×10⁹ s, or less than 100 ps. It cannot respond in less than Ops, so that means that Ops to 100 ps covers 14 standard deviations. So, the standard deviation is 100/14=7.14 ps. The overall delay (the sum of all the jitter delays) after thousands of iterations through the transceiver 101,102 can, therefore, be determined. The standard deviation of sum of the jitter delays is the square root of the number of iterations, multiplied by the jitter standard deviation. So for 2500 iterations, the standard deviation of the overall jitter would be 7.14 ps×\sqrt{2500}=357 ps, or 0.357 ns. Using 4 standard deviations as a required accuracy limit, that would mean that the jitter was accurate to 4×0.357=1.428 ns As the measurement accuracy in this example is 0.25 ns, or 250 ps, the accuracy of the system is limited by the effect of jitter, not time measurement resolution. A longer fibre would reduce the number of iterations per update, so would reduce the size of the standard deviation on the jitter sum, and thereby improve the heading accuracy.

In some applications, the limitations of using a 4 GHz clock to count the delay between CW and CCW pulses will limit heading accuracy; in those cases, an option is to use a digital vernier mechanism to get delay measurement accuracy that is equal to +4 or +5 standard deviations (i.e., between 4×7.14 ps=28.56 ps and 5×7.14 ps=35.7 ps for this example case).

So far, it has been assumed that the mean response time of the transceiver 101, 102 is half of its worst-case response time, so 50 ps for a 10 Gbps transceiver 101,102. The mean may lie somewhere between the best possible response for a given temperature, and the worst-possible response at that temperature. Always, this will be within the 0-to-specification limits, which means it will produce a standard deviation smaller than the one calculated above; this means the accuracy of the heading estimate will be better than calculated, and the 250 ps time measurement resolution (from a 4 GHz clock) could end up being the lower limit on the system's heading resolution.

A Skew-Normal distribution may be capable of closely describing the actual distribution.

A worst-case distribution could be considered as uniform distribution; however, the sum of uniformly distributed jitters will tend towards a normal distribution. The variance of the sum of samples from a uniform distribution between 0 and 1 is P/12, where P is the number of samples summed—that is, the number of jitters summed. When a distribution is scaled by A, its standard deviation is also scaled by A. So, for a 0 to 100 ps uniform distribution, with 2500 iterations, the standard deviation would be

$$100 \times \sqrt{\frac{2500}{12}} = 1443.4 ps ,$$

which is 1.44 ns.

A standard deviation of 1.44 ns compares with a standard deviation of 0.3575 ns for the sum of normally distributed jitters (calculated above). Therefore, the 4 standard deviations accuracy range for a uniformly distributed jitter would tend to be larger than that of a normally distributed jitter between 0 ps and 100 ps. So the heading accuracy would be a bit poorer than that of normal distribution. It is likely that other non-normal distributions (e.g., Skew Normal) would also produce jitter sums that would tend towards normal variances, following the Central Limit Theorem. A normal distribution is considered a useful approximation.

### SUMMARY

There are, therefore, at least four implementations of the recirculating gyroscope concept:
1. CW and CCW coil pairs mounted at 90° to each other. This gives the same heading accuracy at any latitude.
2. CW and CCW coils mounted vertically. This suffers from decreasing heading accuracy as latitude increases north or south.
3. Dual CW coils mounted at 90° to each other. This gives the same heading accuracy at any latitude. The coils could be CCW with no loss of accuracy.
4. Single CW coil mounted vertically. This suffers from decreasing heading accuracy as latitude increases north or south. The coil could be CCW with no change in accuracy.

A 20 Hz update rate could use a single vertical coil, a 10 Gbps transceiver and a single 250 m fibre coil. To get better accuracy, a vertical coil and a horizontal coil could be used, with a total length of km, and a 50 Gbps transceiver. The longer coil reduces the number of iterations per update, and the high bandwidth transceiver reduces the jitter per iteration. A higher accuracy might be obtained from a system using clockwise and counter clockwise coils, also arranged in vertical and horizontal pairs. Again, a higher bandwidth transceiver would also improve angular resolution.

In this specification the terms “recirculation” and “retransmission” are used interchangeably (likewise for variations of those words such as “recirculate” and “retransmit”).

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A gyroscope comprising:
a transmitter configured to transmit a signal, the time of the first signal transmission defining the start of a sample period;
a receiver configured to receive the signal;
a path connecting the transmitter and receiver, along which the signal travels; and
a processor, wherein:
the transmitter is configured to retransmit the signal in response to the signal being received at the receiver throughout the sample period;
the processor is configured to determine the time between the first signal transmission and the reception of the final retransmitted signal when the sample period has ended; and
the processor is further configured to use the time between the first signal transmission and the reception of the final retransmitted signal to determine a corresponding rotation of the gyroscope over the sample period.

2. A gyroscope according to claim 1, further including a clock, wherein the processor is configured to use the clock to determine the time between the first signal transmission and the reception of the final retransmitted signal when the sample period has ended.

3. A gyroscope according to claim 1, further including a vernier delay line time-to-digital converter, wherein the processor is configured to use the vernier delay line time-to-digital converter to determine the time between the first signal transmission and the reception of the final retransmitted signal when the sample period has ended.

4. A gyroscope according to claim 1, wherein the processor is configured to determine the rotation of the gyroscope by comparing the time between the first signal transmission and the reception of the final retransmitted signal to an expected time based on the sample period.

5. A gyroscope according to claim 1, wherein the path includes a coiled portion.

6. A gyroscope according to claim 5, wherein the path includes a first coiled portion defining a first plane and a second coiled portion defining a second plane, wherein the first and second planes are rotationally offset with respect to each other.

7. A gyroscope according to claim 6, wherein the first and second planes are substantially orthogonal to each other.

8. A gyroscope according to claim 7, wherein, in use, the first plane is substantially horizontal and the second plane is substantially vertical.

9. A gyroscope according to claim 1, wherein the sample period is at least 25 μs.

10. A gyroscope according to claim 1, wherein the path includes a primary route and an alternative route, and the gyroscope further includes:
a splitter configured to direct part of the signal along the primary route and part of the signal along the alternative route; and
a combiner configured to direct signals from the primary and alternative routes to the receiver.

11. A gyroscope according to claim 10, wherein the primary route and alternative routes are of different lengths.

12. A gyroscope according to claim 10, further including a multiplexer configured to pass only one of the received signals from the primary and alternative paths to the transmitter for retransmission.

13. A gyroscope according to claim 1, wherein the signal includes an optical signal.

14. A gyroscope according to claim 1, wherein the gyroscope is a fibre optic gyroscope and the path includes a fibre optic cable.

15. A gyroscope according to claim 1, wherein the transmitter and receiver are provided as a transceiver.

16. (canceled)

17. A method for measuring rotation of a system, the method comprising:
transmitting a signal along a path, the time of the first signal transmission defining the start of a sample period;
receiving the signal at a receiver;
throughout the sample period, in response to receiving the signal at the receiver, retransmitting the signal from the transmitter;
determining the time between the first signal transmission and the reception of the final retransmitted signal when the sample period has ended; and
using the time between the first signal transmission and the reception of the final retransmitted signal to determine a corresponding rotation of the system over the sample period.

18. A system for determining linear velocity, comprising:
a first transmitter and a first receiver;
a second transmitter and a second receiver;
a first path connecting the first transmitter to the first receiver;
a second path connecting the second transmitter to the second receiver; and
a processor, wherein:
the first transmitter is configured to transmit a signal to the first receiver, the time of the first signal transmission defining the start of a sample period;
the second transmitter is configured to retransmit the signal to the second receiver in response to the signal being received at the first receiver throughout the sample period;
the first transmitter is further configured to retransmit the signal to the first receiver in response to the retransmitted signal being received at the second receiver throughout the sample period;
the first and second paths have different baseline signal travel times;
the processor is configured to determine the time between the first signal transmission and the reception of the final retransmitted signal at the first or second receiver when the sample period has ended; and
the processor is further configured to use the time between the first signal transmission and the reception of the final retransmitted signal at the first or second receiver to determine a corresponding linear velocity over the sample period.

19. A system according to claim 18, wherein the first transmitter and second receiver are provided as a first transceiver, and the second transmitter and first receiver are provided as a second transceiver.

20. A system according to claim 18 or 19, wherein the first and second paths have different signal propagation speeds and/or are of different lengths, resulting in the different baseline signal travel times, wherein the first and second paths are of different lengths, and wherein at least one of the first and second paths includes an extension section, the extension section including a helical or spiral portion.

21.-25. (canceled)
